(19) United States
(12) Patent Application Publication
(10) Pub. No.: US 2008/0297734 A1
(43) Pub. Date: Dec. 4, 2008

(54) PROJECTION DISPLAY DEVICE AND METHOD FOR CONTROLLING OFF-BEAMS THEREOF

(75) Inventor: Jeong-phil SEO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/099,189

(22) Filed: Apr. 8, 2008

(30) Foreign Application Priority Data
May 30, 2007 (KR) 10-2007-0052664

(51) Int. Cl. G03B 21/28

(52) U.S. Cl. 353/81; 353/99; 353/88

(57) ABSTRACT

A projection display device and a method for controlling off-beams thereof are provided. The projection display device includes a case, a light source which is disposed in the case and outputs color light, a digital micro mirror device (DMD) which is disposed in the case, and controls micro mirrors and reflects the color light received from the light source, thereby outputting on-beams and off-beams, and an output unit which is disposed in the case and allows the off-beams output from the DMD to be projected to the outside of the case. Accordingly, the off-beams output from the DMD are output to the outer case through a shutter, prism, color filter, or an integral lens, so that a color of the outer case can be adjusted and also an exterior of the projection display device can be brightened.

### CROSS-REFERENCE TO RELATED APPLICATIONS

This application claims priority under 35 U.S.C. §119 from Korean Patent Application No. 10-2007-52664, filed on May 30, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a projection display device and a method for controlling off-beams thereof, and more particularly, to a projection display device which transmits off-beams output from a digital micro mirror device to the outside of the projection display device, and a method for controlling off-beams thereof.

2. Description of the Related Art

Generally, a display device displays images on a screen by projecting image signals composed of red (R), green (G), and blue (B) color signals onto the screen. In related art, the display device used a cathode ray tube (CRT), but in recent years, there has been an increasing use of projection type display devices. Among the projection type display devices, the use of a digital light processing (DLP) display device, which is a so-called third generation projection device, has been noticeably increased.

The DLP display device uses a semiconductor chip, which is called a digital micro mirror device (DMD) comprising 1,300,000 or more micro mirrors. The micro mirrors are able to be individually and separately controlled. The DLP display device adjusts the slope of the DMD and scans one of R-light, G-light, and B-light that corresponds to a color of an image to display onto a projection lens, thereby displaying an image.

The light scanned onto the projection lens by adjusting the slope of the DMD is referred to as “on-beams”, whereas among the R-light, G-light, and B-light incident on the DMD, the light reflected onto parts other than the projection lens is referred to as “off-beams.”

However, a related art DLP display device uses the on-beams but does not use the off-beams to display images. That is, there is a problem of wasted off-beams. In order to address this problem, a solution is demanded to utilize the wasted off-beams.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a user terminal, an image display device, and a method for adjusting a light source thereof, in which a light source of a backlight unit can be adjusted based on a luminance determined according to ambient light and according to the light source.

The present invention provides a projection display device which is capable of adjusting a color and a brightness of an outer case or external device thereof by using off-beams, and a method for controlling the off-beams thereof

According to an aspect of the present invention, there is provided a projection display device comprising: a case; a light source which is disposed in the case and outputs color light; a digital micro mirror device (DMD) which is disposed in the case, and controls micro mirrors and reflects the color light received from the light source, thereby outputting on-beams and off-beams; and an output unit which is disposed in the case and allows the off-beams output from the DMD to be projected to the outside of the case.

According to an aspect of the present invention, at least a part of the case may be made of a semitransparent material.

The output unit may comprise at least one inner optical fiber to transmit the off-beams to the outside of the case.

The case may comprise an outer optical fiber to allow the off-beams transmitted through the inner optical fiber to be projected to the outside of the case.

The output unit may comprise either an active element which is disposed between the DMD and the case and adjusts an amount of off-beams projected to the outside of the case, or a passive element which is disposed between the DMD and the case and adjusts an amount of off-beams projected to the outside of the case.

The active element which adjusts the amount of off-beams may be either a shutter or a color filter, and the passive element which adjusts the amount of off-beams may be either an integral lens or a prism.

The output unit may comprise a shutter, and if the output unit is the shutter, the projection display device may further comprise a controller which outputs on-signals or off-signals to control on/off operations of the shutter.

If the on-signals are received from the controller to turn on the shutter, the shutter may output the off-beams to the outside of the case, and if the off-signals are received from the controller to turn off the shutter, the shutter may block the off-beams.

According to another aspect of the present invention, there is provided a method for controlling off-beams of a projection display device which comprises a case containing a light source, the method comprising: outputting a color light; outputting on-beams and off-beams as a result of controlling micro mirrors and of reflecting the color light; and projecting the output off-beams to the outside of the case.

The operation of projecting the off-beams may comprise projecting the off-beams to the outside of the case through an inner optical fiber provided in the case.

According to an aspect of the present invention, a plurality of the inner optical fibers may be provided.

The operation of projecting the off-beams may comprise projecting the off-beams transmitted through the inner optical fiber to the outside of the case through an outer optical fiber connected with outside of the case.

The operation of projecting the off-beams may comprise projecting the off-beams to an external device connected with the outer optical fiber.

According to an aspect of the present invention, the external device may comprise a light device.

The method for controlling the off-beams may further comprise: outputting on-signals or off-signals to control on/off operations of the shutter if the output off-beams are transmitted to the outside of the projection display device by the shutter; and the shutter transmitting the off-beams to the outside if the on-signals are received to turn on the shutter, and blocking the off-beams if the off-signals are received to turn off the shutter.

### BRIEF DESCRIPTION OF THE DRAWINGS

The above and other aspects of the present invention will be more apparent from the following detailed description of exemplary embodiments of the present invention with reference to the accompanying drawings, in which:

FIG. 1 is a block diagram illustrating a DLP display device according to an exemplary embodiment of the present invention;

FIG. 2 is a block diagram illustrating a DLP display device according to another exemplary embodiment of the present invention;

FIG. 3 is a block diagram illustrating a DLP display device according to still another exemplary embodiment of the present invention;

FIG. 4 is a block diagram illustrating a DLP display device according to still another exemplary embodiment of the present invention;

FIG. 5 is a flowchart illustrating a method for operating a DLP display device according to an exemplary embodiment of the present invention;

FIG. 6 is a block diagram illustrating a projection display device according to an exemplary embodiment of the present invention; and

FIG. 7 is a flowchart illustrating a method for operating a projection display device according an exemplary embodiment of the present invention.

### DETAILED DESCRIPTION OF EXEMPLARY EMBODIMENTS

Hereinafter, exemplary embodiments of the present invention will be described in detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

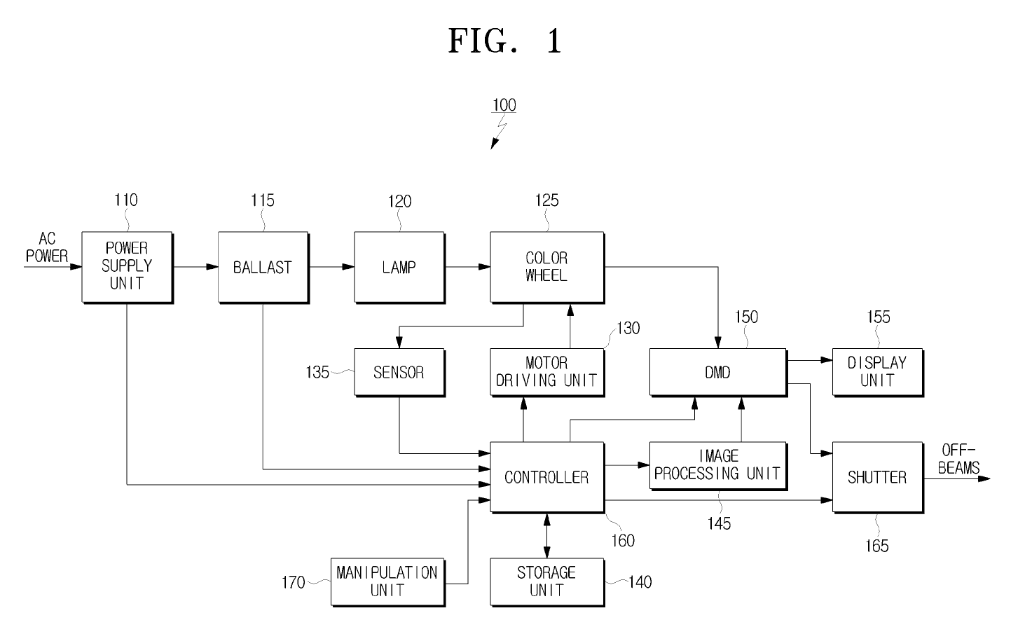

FIG. 1 is a block diagram illustrating a DLP display device according to an exemplary embodiment of the present invention. Referring to FIG. 1, a DLP display device 100 comprises a power supply unit 110, a ballast 115, a lamp 120, a color wheel 125, a motor driving unit 130, a sensor 135, a storage unit 140, an image processing unit 145, a DMD 150, a display unit 155, a controller 160, a shutter 165, and a manipulation unit 170. These elements are disposed in an outer case (not shown) of the DLP display device 100.

The power supply unit 110 is input with an AC power from the outside and supplies it to the respective elements of the DLP display device 100.

The ballast 115 converts the AC power received from the power supply unit 110 into a second power suitable for driving the lamp 120, and outputs the second power to the lamp 120.

The lamp 120 generates white light based on the second power output from the ballast 115.

The color wheel 125 comprises filters through which the lights of R, G, and B wavelengths are passed, respectively. The R, G, and B filters are alternately located on a light path when the color wheel 125 is rotated, and output the white light received from the lamp 120 as R, G, and B colors. That is, images corresponding to the respective colors are overlapped with one another during one revolution of the color wheel 125 so that one frame image is generated.

The motor driving unit 130 drives a motor connected with the color wheel 125 to rotate the color wheel 125.

The sensor 135 senses a phase and a rotational speed of the color wheel 125 as the color wheel 125 is operated.

The storage unit 140 stores therein a program and an image file to control the entire operation of the DLP display device 100.

With reference to the storage unit 140, the image processing unit 145 converts image signals received from the controller 160, which will be described later in detail, into image data having a format suitable for driving the DMD 150, and outputs the image data. The DMD 150 comprises about 1,300,000 micro mirrors, and outputs the image data output from the image processing unit 145 to the display unit 155. Also, the DMD 150 reflects the R, G, and B colors output from the color wheel 125 using the micro mirrors, and output the reflected R, G, and B colors. That is, the DMD 150 reflects the image data output from the image processing unit 145 and the R, G, B colors output from the color wheel 125, thereby realizing an image to display on the display unit 155. The DMD 150 outputs to the display unit 155 on-beams that are the light reflected as a result of controlling the micro mirrors in order to output the R, G, B colors to the display unit 155. Also, the DMD 150 outputs to the shutter 165 off-beams that are the light reflected as a result of controlling the micro mirrors in order to output the R, G, B colors to the outside of the display unit 155.

The controller 160 controls the entire operation of the DLP display device 100, and outputs a control signal to the shutter 165 in order to control on/off operation of the shutter 165 based on the phase and the rotational speed of the color wheel 125 output from the sensor 135. Specifically, the controller 160 synchronizes the color wheel 125 and the shutter 165 and controls the on/off operation of the shutter 165 such that a pre-set color is output from the shutter 165. That is, if the pre-set color is a red (R) color, the controller 160 calculates the time that is taken for the R-light to be output from the color wheel 125 during one revolution of the color wheel 125, based on the rotational speed of the color wheel 125 sensed by the sensor 135. The controller 160 outputs an on-signal to the shutter 165 to turn on the shutter 165 during the time that the R-light is output from the color wheel 125. Accordingly, off-beams (R-light) output to the shutter 165 from the DMD 150 are emitted to the outer case (not shown) of the DLP display device 100. For example, the outer case may be made of a semitransparent material so that the color derived from the off-beams can be seen from the outside. However, this should not be considered as limiting and a part of the outer case may be made of a semitransparent material.

The controller 160 is aware of what color is output from the color wheel 125 based on the phase of the color wheel 125 sensed by the sensor 135. If the color output from the color wheel 125 is not the pre-set red (R) color, the controller 160 outputs an off-signal to the shutter 165 to turn off the shutter 165. Accordingly, the shutter 165 prevents off-beams (G-light and B-light) output from the DMD 150 from being transmitted to the outer case (not shown) of the DLP display device 100. In this non-limiting exemplary embodiment, the color of the off-beams transmitted to the outer case is previously set. The user can input any color he/she wishes to set through the manipulation unit 170.

The DLP display device 100 may comprise at least one inner optical fiber (not shown) to transmit the off-beams from the shutter 165 to outside of the outer case. However, this should not be considered as limiting and a plurality of optical fibers may be provided. The inner optical fiber provided in the outer case is enclosed with a light-shielding material. Therefore, the user can see the off-beams projected to the outside of the outer case through the inner optical fiber.

Also, an outer optical fiber may be provided in the outer case, and it may be connected with the inner optical fiber in the outer case. The outer optical fiber may be disconnected from the outer case by the user's manipulation, and also may be connected with a lighting device such a lamp. In other words, the off-beams are transmitted to the lighting device through the outer optical fiber.

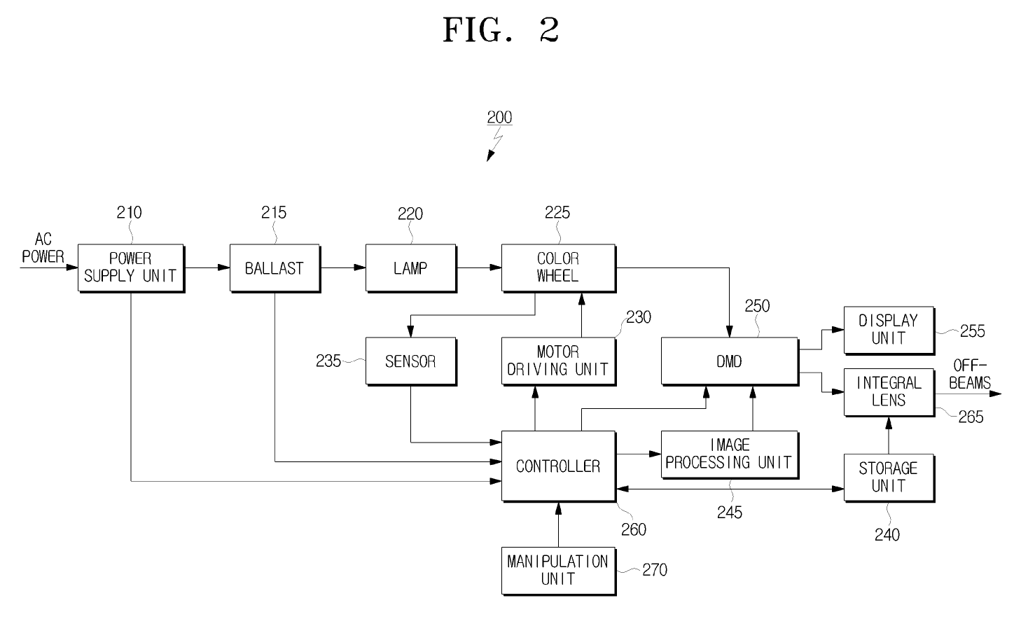

FIG. 2 is a block diagram illustrating a DLP display device according to another exemplary embodiment of the present invention. The DLP display device shown in FIG. 2 uses an integral lens 265 instead of the shutter 165 of FIG. 1. Since the elements of FIG. 2 are similar to those of FIG. 1 in their substantial operations, the detailed descriptions thereof will be omitted.

A storage unit 240 stores a pre-set off-beam output level which represents a color of off-beams to output to an outer case of a DLP display device 200. Herein, the off-beam output level should not be limited as being previously set and can be input by a user using a manipulation unit 270.

A controller 260 controls such that off-beams output from a DMD 250 are output to an inner optical fiber located in a predetermined range through the integral lens 265. Operation of transmitting the off-beams through the inner optical fiber is same as that of the controller 160 of FIG. 1, and thus a detailed description thereof will be omitted.

The integral lens 165 collects the off-beams output from the DMD 250, and adjusts an amount of collected off-beams according to the pre-set off-beam output level and output the off-beams.

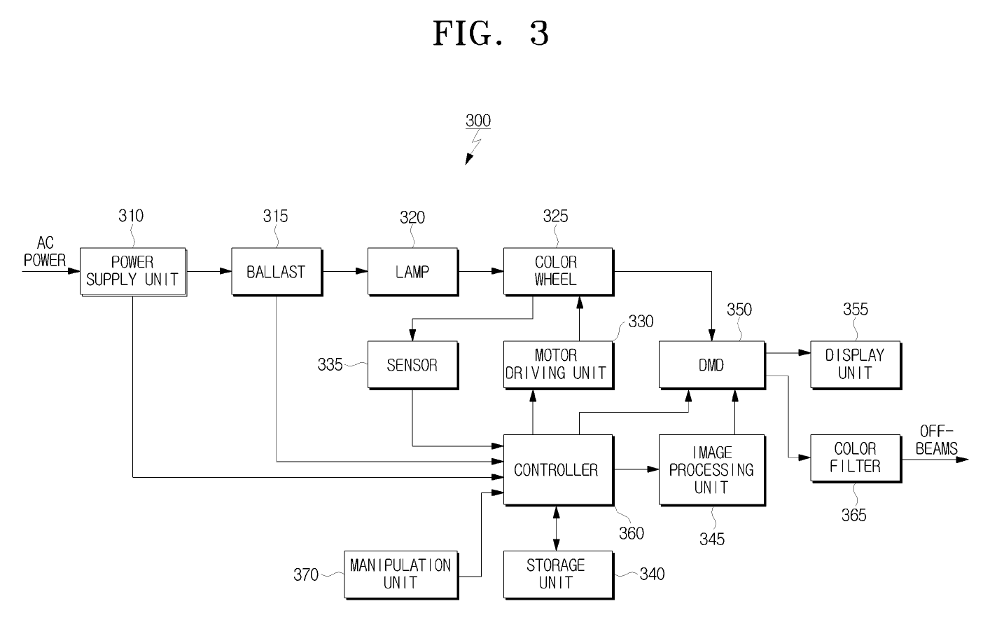

FIG. 3 is a block diagram illustrating a DLP display device according to still another exemplary embodiment of the present invention. The DLP display device shown in FIG. 3 uses a color filter 365 instead of the shutter 165 of FIG. 1. Since the elements of FIG. 3 are similar to those of FIG. 1 in their substantial operations, the detailed descriptions thereof will be omitted.

A controller 360 controls such that off-beams output from a DMD 350 is output to an optical fiber located in a predetermined range through the color filter 365. Operation of transmitting the off-beams through the optical fiber is same as that of the controller 160 of FIG. 1, and thus a detailed description thereof will be omitted.

Of the off-beams output from the DMD 350, the color filter 365 outputs off-beams that represent a specific color, while blocking the other colors of the off-beams. That is, if the color filter 365 is a blue (B) color filer, the color filter 365 passes blue off-beams only therethrough and outputs them to an outer case (not shown), while blocking off-beams other than the blue off-beams. The color filter 365 and the shutter 165 of FIG. 1 are disposed between the DMD 350 (150, FIG. 1) and the outer case, and they are both active elements having a common feature of adjusting the amount of off-beams projected to the outside of the outer case.

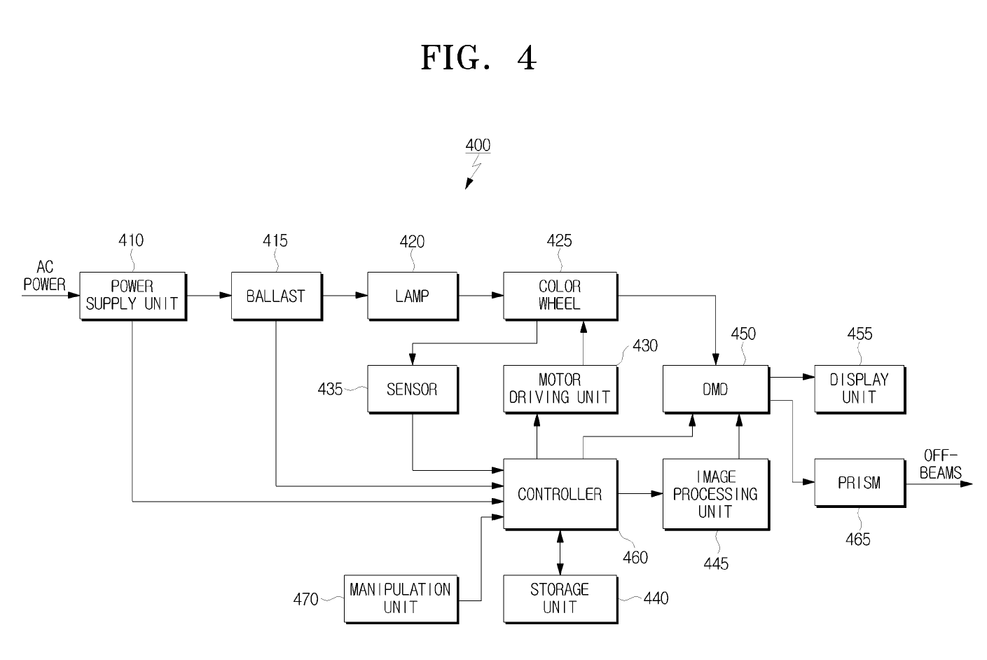

FIG. 4 is a block diagram illustrating a DLP display device according to still another exemplary embodiment of the present invention. The DLP display device shown in FIG. 4 uses a prism 465 instead of the shutter 165 of FIG. 1. Since the elements shown in FIG. 4 are similar to those of FIG. 1 in their substantial operations, the detailed descriptions thereof will be omitted.

A controller 460 controls such that off-beams output from a DMD 450 are output to an optical fiber located in a predetermined range through the prism 465. Operation of transmitting the off-beams through the optical fiber is similar to that of the controller 160 of FIG. 1, and thus a detailed description thereof will be omitted.

The prism 465 passes the off-beams output from the DMD 450 therethrough, and outputs the light of various spectrums. That is, the off-beams output from the DMD 450 pass through the prism 465 and are output to an outer case (not shown) as a light representing rainbow colors.

The prism 465 and the integral lens 265 of FIG. 2 are disposed between the DMD 450, 250 and the outer case, and they are both passive elements a common feature of adjusting the amount of off-beams projected to the outside of the outer case.

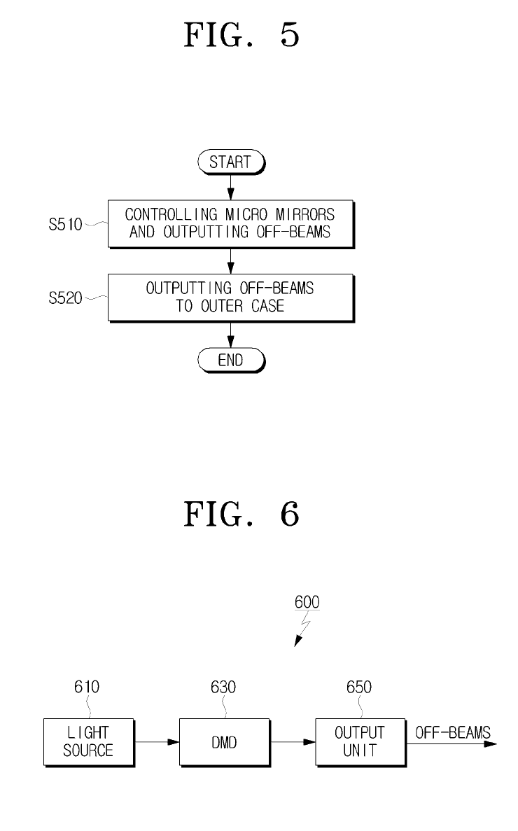

FIG. 5 is a flowchart illustrating a method for operating the DLP display device according to an exemplary embodiment of the present invention.

Referring to FIG. 5, the DMD 150 controls the micro mirrors provided therein and outputs reflected off-beams at operation S510. More specifically, the DMD 150 controls the micro mirrors such that the respective R, G, B colors output from the color wheel 125 are reflected to the part other than the display unit 155 and off-beams are output. Simultaneously, the DMD 150 controls the micro mirrors such that the respective R, G, B colors are reflected to the display unit 155 and on-beams are output to the display unit 155 to be able to realize an image to display.

Next, the shutter 165 outputs the off-beams to the outer case at operation S520. More specifically, if an on-signal is received from the controller 160, the shutter 165 is turned on to output the off-beams output at operation S510 to the outer case. The outer case may be made of a semitransparent light receiving material and encloses the DLP display device 100. If an off-signal is received from the controller 160, the shutter 165 is turned off to prevent the off-beams output at operation S510 from passing therethrough.

At operation S520, the shutter 165 outputs the off-beams to the outer case. However, this should not be considered as limiting. The shutter 165 may transmit the off-beam to an external device connected thereto through an optical fiber (not shown). A lighting device exemplifies the external device.

Also, at operation S520, the off-beams output at operation S510 are output to the outer case through the shutter 165. However, this should not be considered as limiting. The off-beams output at operation S510 may be output to either of the outer case and the external device through the integral lens 265, the color filter 365, or the prism 465.

Also, at operation S520, the controller 160 outputs the off-beams output at operation S510 from the shutter 165 to the optical fiber located in a predetermined range. The optical fiber may connect from an inside of the outer case to a predetermined area or to outside of the outer case. The optical fiber connected with the outside of the outer case may be disconnected from the outer case by the user's manipulation, and may be connected with a lighting device such as a lamp. Accordingly, the user can see the off-beams emitted through the optical fiber provided in the outer case.

The optical fiber provided in the outer case or connecting from the outer case to the external device should not be limited as one optical fiber. A plurality of optical fibers may be used. The optical fiber may be made of a semitransparent material so that the color derived from the off-beams can be seen from the outside, and the optical fiber provided in the outer case may be enclosed by a light-shielding material.

FIG. 6 is a block diagram illustrating a projection display device according to an exemplary embodiment of the present invention. The projection display device 600 comprises a light source 610, a DMD 630, and an output unit 650, which are all provided in a case (not shown).

The DMD 630 controls micro mirrors provided therein such that color lights output from the light source 610 are reflected and output as on-beams or off-beams.

The output unit 650 projects the off-beams output from the DMD 630 to the outside of the case.

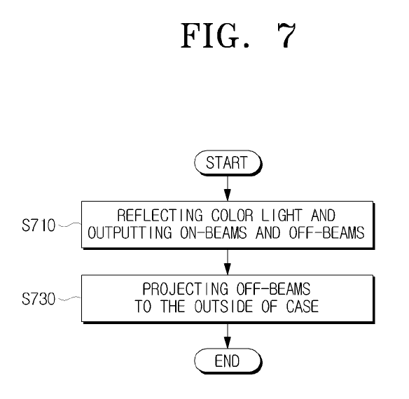

FIG. 7 is a flowchart illustrating a method for operating a projection display device according an exemplary embodiment of the present invention.

Referring to FIG. 7, the DMD 630 controls the micro mirrors such that the incoming color lights are reflected and output as on-beams and off-beams at operation S710. Next, the output unit 650 projects the off-beams output from the DMD 630 to the outside of the case at operation S730.

According to an exemplary embodiment of the present invention, the off-beams reflected by the micro mirrors provided in the DMD 150 are output to the entire part of the outer case (not shown) enclosing the DLP display device 100 through an optical device such as the shutter 165, the integral lens 265, the color filter 365, or the prism 465. However, this should not be considered as limiting. The off-beams may be output to a predetermined area such as a trademark or logo provided on the outer case.

Also, according to an exemplary embodiment of the present invention, the off-beams output through the shutter 165, the integral lens 265, the color filter 365, or the prism 465 are used for the purpose of representing the color of the outer case. However, this should not be considered as limiting. The off-beams output through the shutter 165, the integral lens 265, the color filter 365, or the prism 465 are output to an external device (not shown) through an interface (not shown). One representative example of the external device is a lamp. That is, the off-beams output from the shutter 165, the integral lens 265, the color filter 365, or the prism 465 are transmitted through an optical fiber located in a predetermined range of a peripheral area of the shutter 165, the integral lens 265, the color filter 365, or the prism 465, and are used for the purpose of lighting with the lamp connected with the optical fiber.

A light collecting lens (not shown) is located after the shutter 165, the integral lens 265, the color filter 365, or the prism 465, to pass the off-beams output from the shutter 165, the integral lens 265, the color filter 365, or the prism 465 therethrough, and output them to the optical fiber. Also, a dispersion lens is located after the shutter 165, the integral lens 265, the color filter 365, or the prism 465, to pass the off-beams output from the shutter, 165, the integral lens 265, the color filter 365, or prism 465 therethrough, and output them to the outer case (not shown).

According to an exemplary embodiment of the present invention, the off-beams are output when R-light, G-light, and B-light, which are color-separated through the color wheel 125, are passed through the DMD 150. However, this should not be considered as limiting. The light wasted in another device using a color gamut different from RGB may be used as off-beams.

According to an exemplary embodiment of the present invention, the light source outputs the color light separated from the white light using the lamp 120, 220, 320, and 420 and the color wheel 125, 225, 325, and 425. However, this should not be considered as limiting. The light source may directly output the color light using an R/G/B diode instead of the lamp 120 and the color wheel 125.

As described above, the off-beams output from the DMD 150, 250, 350, 450 are output to the outer case through the shutter 165, the prism 465, the color filter 365, or the integral lens 265, so that a color of the outer case can be adjusted and also the exterior of the projection display device can be brightened.

Also, since the off-beams output from the DMD 150, 250, 350, 450 are transmitted to an external device connected with the projection display device, the wasted light can be effectively used.

The foregoing exemplary embodiments and features are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A projection display device comprising:
a case:
a light source which outputs color light;
a digital micro mirror device (DMD) which controls micro mirrors and reflects the color light received from the light source, thereby outputting on-beams and off-beams; and
an output unit which causes the off-beams output from the DMD to be projected to outside of the case,
wherein at least one of the light source, the DMD and the output unit is disposed in the case.

2. The projection display device as claimed in claim 1, wherein at least a part of the case is made of a semitransparent material.

3. The projection display device as claimed in claim 1, wherein the output unit comprises at least one inner optical fiber to transmit the off-beams to the outside of the case.

4. The projection display device as claimed in claim 3, wherein the case comprises an outer optical fiber to allow the off-beams transmitted through the at least one inner optical fiber to be projected to the outside of the case.

5. The projection display device as claimed in claim 1, wherein the output unit comprises either an active element which is disposed between the DMD and the case and adjusts an amount of off-beams projected to the outside of the case, or a passive element which is disposed between the DMD and the case and adjusts an amount of off-beams projected to the outside of the case.

6. The projection display device as claimed in claim 5, wherein the active element which adjusts the amount of off-beams is either a shutter or a color filter, and the passive element which adjusts the amount of off-beams is either an integral lens or a prism.

7. The projection display device as claimed in claim 1, wherein the output unit comprises:
a shutter which allows or blocks the off-beams from the DMD from being transmitted to the outside of the case; and
a controller which outputs on-signals or off-signals to control on/off operations of the shutter.

8. The projection display device as claimed in claim 7, wherein if the on-signals are received from the controller to turn on the shutter, the shutter outputs the off-beams to the outside of the case, and if the off-signals are received from the controller to turn off the shutter, the shutter blocks the off-beams.

9. A method for controlling off-beams of a projection display device which comprises a case containing a light source, the method comprising:
outputting a color light;
controlling the micro mirrors to reflect the colored light, thereby outputting on-beams and off-beams; and
projecting the output off-beams to outside of the case.

10. The method for controlling off-beams of a projection display device as claimed in claim 9, wherein the operation of projecting the off-beams comprises projecting the off-beams to the outside of the case through an inner optical fiber provided in the case.

11. The method for controlling off-beams of a projection display device as claimed in claim 10, wherein a plurality of the inner optical fibers are provided.

12. The method for controlling off-beams of a projection display device as claimed in claim 9, wherein the operation of projecting the off-beams comprises projecting the off-beams transmitted through the inner optical fiber to the outside of the case through an outer optical fiber connected with the outside of the case.

13. The method for controlling off-beams of a projection display device as claimed in claim 12, wherein the operation of projecting the off-beams comprises projecting the off-beams to an external device connected with the outer optical fiber.

14. The method for controlling off-beams of a projection display device as claimed in claim 13, wherein the external device comprises a light device.

15. The method for controlling off-beams of a projection display device as claimed in claim 9, further comprising:
outputting on-signals or off-signals to control on/off operations of the shutter if the output off-beams are transmitted to the outside of the case by the shutter;
wherein the shutter transmitts the off-beams to the outside if the on-signals are received to turn on the shutter, and blocks the off-beams if the off-signals are received to turn off the shutter.

16. A projection display device comprising:
a case;
a light source which outputs color light;
a digital micro mirror device (DMD) which controls micro mirrors and reflects the color light received from the light source, thereby outputting on-beams and off-beams; and
an output unit which receives the off-beams output from the DMD and transmits the off-beams to a first area that is different than a second area to which the on-beams are output.

17. The projection display device as claimed in claim 16, wherein the output unit causes the off-beams to be projected to outside of the case.

18. The projection display device as claimed in claim 16, wherein at least one of the light source, the DMD and the output unit is disposed in the case.
